(19) United States
(12) Patent Application Publication
(10) Pub. No.: US 2003/0201898 A1
(43) Pub. Date: Oct. 30, 2003

(54) Blockage detector with separate alarm and shut-off functions

(76) Inventor: Charles F. Stuchlik III, Tucson, AZ (US)

Correspondence Address: OLIFF & BERRIDGE, PLC, P.O. BOX 19928, ALEXANDRIA, VA, 22320, US

(21) Appl. No.: 10/131,039

(22) Filed: Apr. 25, 2002

(51) Int. Cl. G08B 21/00

(52) U.S. Cl. 340/608

(57) ABSTRACT

A blockage detector initially sounds an alarm while permitting the air cooling system to continue to operate when a first level of liquid is detected within the drain pan of an air cooling system. The blockage detector will turn off the air cooling system when a second level of liquid, which is greater than the first level of liquid, is detected in the drain pan of the air cooling system. This enables the resident(s) of the building (which could be a single family-dwelling or a multiple-family dwelling, such as an apartment building) to contact a technician to correct the blockage condition before the air-cooling system is turned off. If the alarm is not detected, or if the blockage is not eliminated quickly enough, the detector will turn off the air cooling system before water overflows from the drain pan and causes water damage to the building.

### BACKGROUND OF THE INVENTION

1. Field of Invention

The present invention relates to blockage detectors, and in particular to blockage detectors that can be incorporated into air cooling systems to detect blockage in portions of the condensate drainage tubing.

2. Description of Related Art

Numerous devices are available for detecting a blockage in the condensate drainage tubing of an air-cooling system, for example, which is included as part of the HVAC system of buildings. As is known, the air-cooling systems include a heat exchange coil that forms condensate, which is caught by a drain pan of the system. The liquid is evacuated from the drain pan through tubing, which leads to the outside of the building or to some drainage area. The drain tubing often includes a U-shaped trap to form a water seal in the drainage path.

The drain tubing is small in diameter, and can become clogged by dirt and mold that accumulates within the drainage tubing.

Systems are available for detecting clogging of the drainage tubing, for example, by detecting that the level of fluid within the drain pan of the air-cooling system is above some predetermined level. One such system is shown in U.S. Pat. No. 5,522,229 to Stuchlik, III et al. The disclosure of U.S. Pat. No. 5,522,229 is incorporated herein by reference in its entirety. When the predetermined level of liquid, indicative of a blockage, is detected within the drain pan, the system of U.S. Pat. No. 5,522,229 sounds an alarm and/or turns off the air cooling system.

Like the above-mentioned patent, other known blockage detectors also sound an alarm and/or turn off the air cooling system when the liquid reaches a predetermined level. While the systems that turn off the air cooling system are successful in preventing condensate from overflowing out of the drain pan, which can cause water damage to the building, it can be inconvenient (and uncomfortable) to the building resident(s) for the air-cooling system to be turned off, particularly if a technician is not available to clear the blockage in the immediate future. While systems that only sound an alarm do not have this problem, such systems can lead to water damage if the alarm is not detected (for example, if the resident(s) of the building is/are out of town when the alarm is sounded) or if the blockage is not eliminated quickly enough.

### SUMMARY OF THE INVENTION

The invention seeks to address the above-identified problems in known blockage detection systems.

According to one aspect of the invention, a blockage detector initially sounds an alarm while permitting the air cooling system to continue to operate when a first level of liquid is detected within the drain pan of an air cooling system. The blockage detector will turn off the air cooling system when a second level of liquid, which is greater than the first level of liquid, is detected in the drain pan of the air cooling system. This enables the resident(s) of the building (which could be a single family-dwelling or a multiple-family dwelling, such as an apartment building) to contact a technician to correct the blockage condition before the air-cooling system is turned off by the detector. On the other hand, if the alarm is not detected, or if the blockage is not eliminated quickly enough, the detector will turn off the air cooling system before water overflows from the drain pan and causes water damage to the building.

As part of the alarm function, the blockage detector can actuate a dialing system that contacts the technician, thereby placing a service call to have the blockage corrected.

### BRIEF DESCRIPTION OF THE DRAWINGS

The invention will be described with reference to the following drawings, in which like reference numerals refer to like elements, and wherein:

FIG. 1 is a diagrammatic view of an air cooling system incorporating the blockage detector of one preferred embodiment of this invention;

FIG. 2 is a perspective view of the air cooling system drain pan, showing the blockage detector and a drain pipe attached to the drain pan;

FIG. 3 is a schematic diagram of the electrical connections made by the blockage detector, its remote panel, a dialing system and the building's air cooling system and power transformer;

FIG. 4 is a perspective view of the blockage detector sensor housing having a square cross section;

FIG. 5 shows the rear surface of the FIG. 4 blockage detector; and

FIG. 6 is an exploded, perspective view of a blockage detector having a circular cross-section sensor housing and the coupling structure by which the sensor housing is attached to the air cooling system drain pan.

### DETAILED DESCRIPTION OF PREFERRED EMBODIMENTS

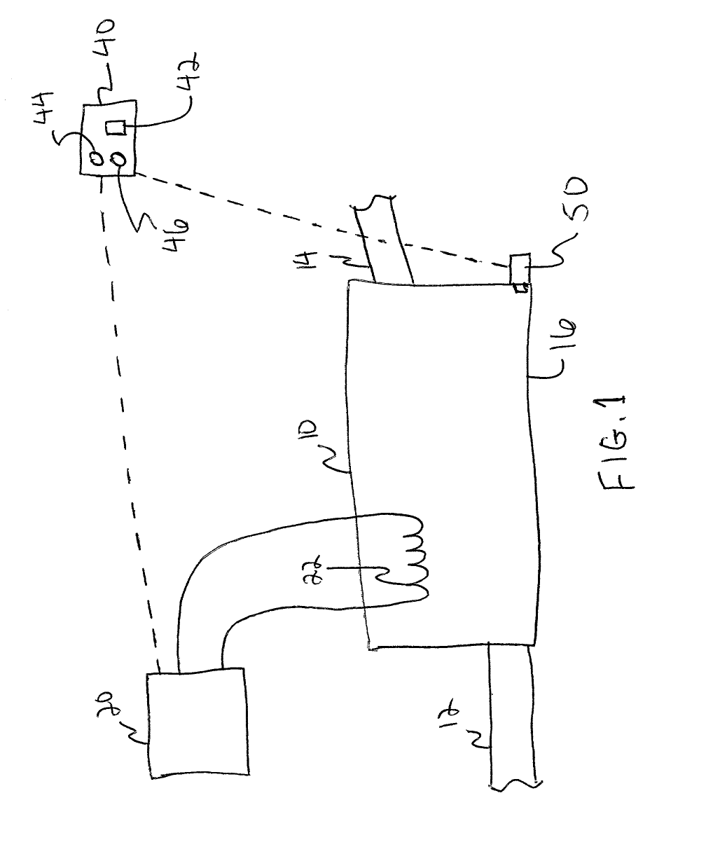

FIG. 1 is a diagrammatic view of an air cooling system including the blockage detector and a remote panel of one embodiment of the invention. The air cooling system includes an air handler 10, which contains the heat exchange coils 22 of an air cooling device 20. The heat exchange coils 22 carry a cold material for cooling warm air conveyed into the air handler 10 through an inlet duct 14. Cooled air is conveyed away from the air handler 10 through outlet duct 12. As the air is cooled, liquid in the air condenses and collects in the drain pan 16 located at the bottom of the air handler 10. As is known, the drain pan 16 also can be a separate pan located below the air handler, and into which condensate drains from the air handler 10.

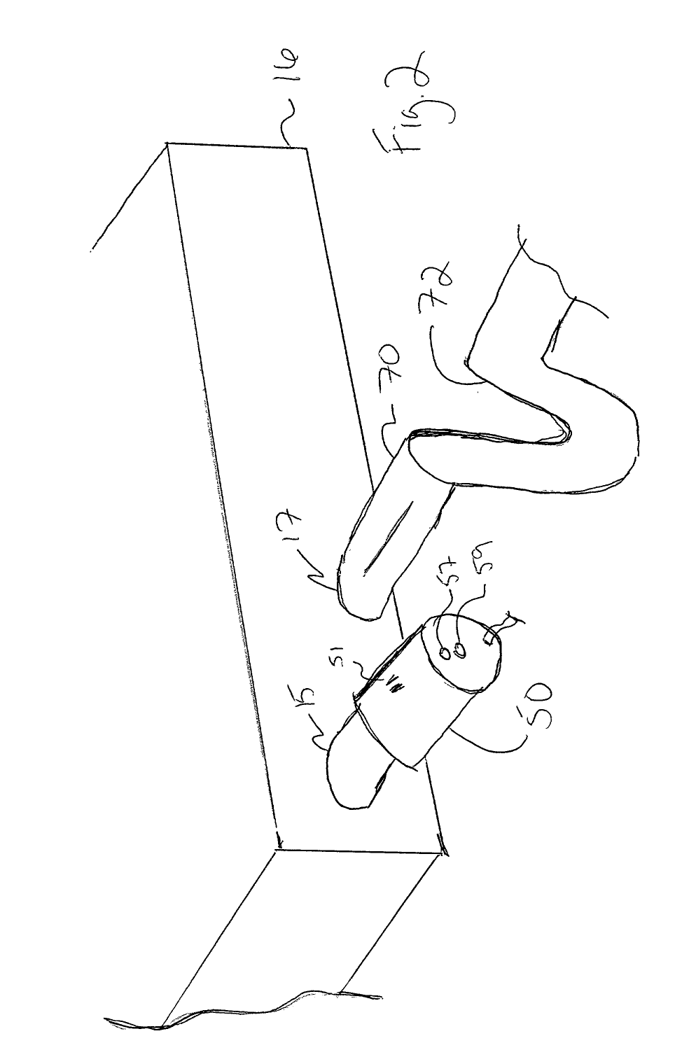

As shown in FIG. 2., the drain pan 16 typically includes an upper outlet 15 and a lower outlet 17. The lower outlet 17 usually is connected to a drain pipe 70, which drains the condensate from the drain pan. The drain pipe 70 typically leads to the outside of the building or to a drainage system within the building. The drain pipe 70 often includes a trap, such as a U-shaped trap 72 in order to form a water seal to prevent external air from entering the air handler 10 through the drain pipe 70. Depending upon the building code where the air cooling system is installed, the upper outlet 15 is either blocked (i.e., not used) or it may be connected to a drainage system.

The blockage detector 50 of the invention can be coupled to the upper outlet 15. Accordingly, if a blockage occurs in the drain pipe 70, the liquid level within the drain pan 16 will rise and reach the upper outlet 15 to which the blockage detector 50 is coupled. The blockage detector is water proof such that liquid will not leak from the upper outlet 15 when the blockage detector 50 is connected to it.

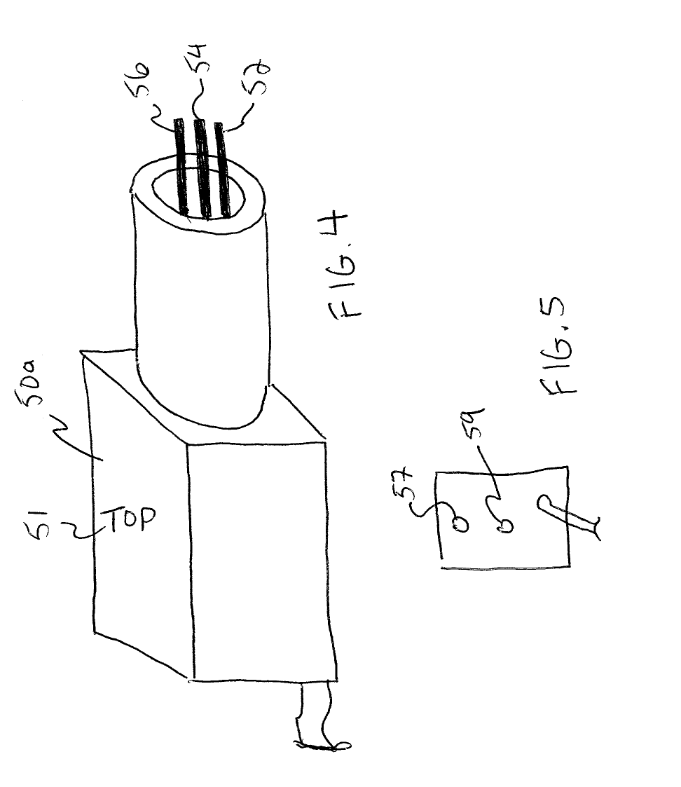

As shown in FIG. 4, the blockage detector includes three contacts 52, 54 and 56. Contact 54 is coupled to a first circuit that controls an alarm. Contact 56 is coupled to a second circuit that controls a supply of power to the air-cooling system 20. Contact 52 is used with each of the contacts 54 and 56, as will be described below, and will be referred to as the common contact.

The blockage detector is coupled to the drain pan 16 such that the contacts are arranged having the vertical orientation illustrated in FIG. 4. In other words, the common contact 52 should be the lowermost of the three contacts, whereas the power-supply contact 56 should be the uppermost of the three contacts. The alarm contact 54 should be located between contacts 52 and 56. It is understood that the three contacts do not need to be located in a straight line and do not need to be oriented perfectly vertically. However, it is only necessary that contact 56 be the uppermost, contact 52 be the lowermost, and contact 54 be located between contacts 52 and 56. When liquid rises to the level at which the alarm contact 54 is located, current will pass between contacts 52 and 54. This will cause an alarm circuit to be closed, thereby sounding an alarm. For example, referring to FIG. 1, a remote panel 40, mounted at a convenient location within the building, for example, on a wall of the building near a thermostat, includes an audible alarm 42 and a visual alarm, such as a light 44. When the alarm is sounded, the light 44 will be lighted, and the audible alarm 42 will emit its alarm sound. An audible alarm shutoff button 46 can be provided on the remote panel 40 in order to turn off the audible alarm 42. Preferably, the light 44 remains lighted until the blockage is eliminated and the liquid falls below the level of contact 54. The remote panel 40 also could be provided as part of a thermostat, as opposed to being a separate control panel.

If the blockage is not eliminated quickly enough, the level of liquid in the drain pan 16 will continue to rise until it reaches the power-supply contact 56. At that time, current will flow between the common contact 52 and the power-supply contact 56, which will then cause the air-cooling system 20 to be turned off. Accordingly, no further condensate will collect, which prevents the drain pan 16 from reaching an overflow condition. The air-cooling system 20 will not be able to be turned back on until the blockage is eliminated and the liquid falls below the level of contact 56.

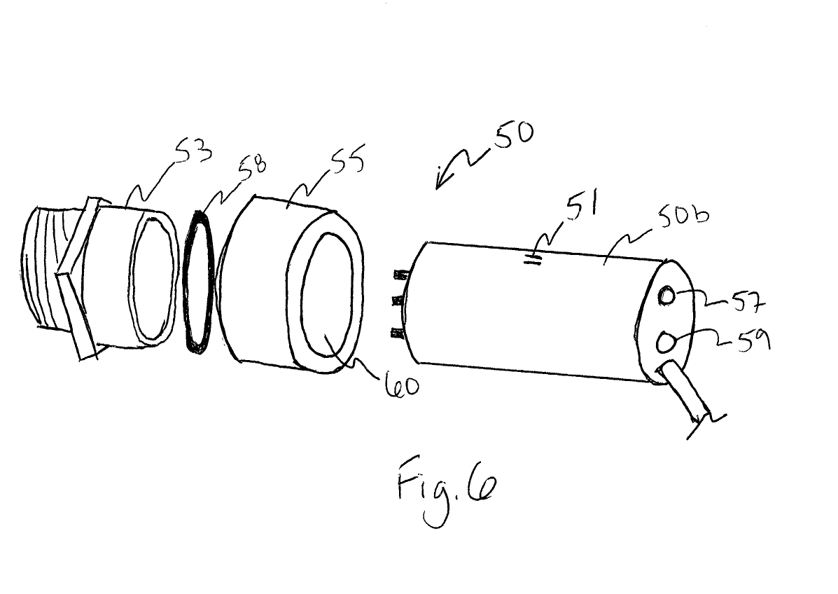

As illustrated in FIGS. 2 and 5, the blockage detector 50 preferably includes, on its rear surface, a two-pole test switch 57 and a light 59. When the user presses the switch 57 once, the alarm circuitry is tested. When the switch 57 is pressed a second time, the power-supply circuitry is tested. In each instance, the light 59 will be illuminated if the circuitry is operating properly. The provision of the test circuitry, switch 57 and light 59, are optional, and do not constitute a main aspect of the invention.

In addition, as illustrated in FIG. 2, it is preferable to include some kind of indicia 51 on the external surface of the blockage detector 50 so as to indicate the proper orientation of the blockage detector 50, such that the contacts 52, 54, 56 are provided in the necessary orientation illustrated in FIG. 4 (i.e., with contact 56 being uppermost, contact 52 being lowermost, and contact 54 being located between contacts 56 and 52) when installed on the drain pan 16.

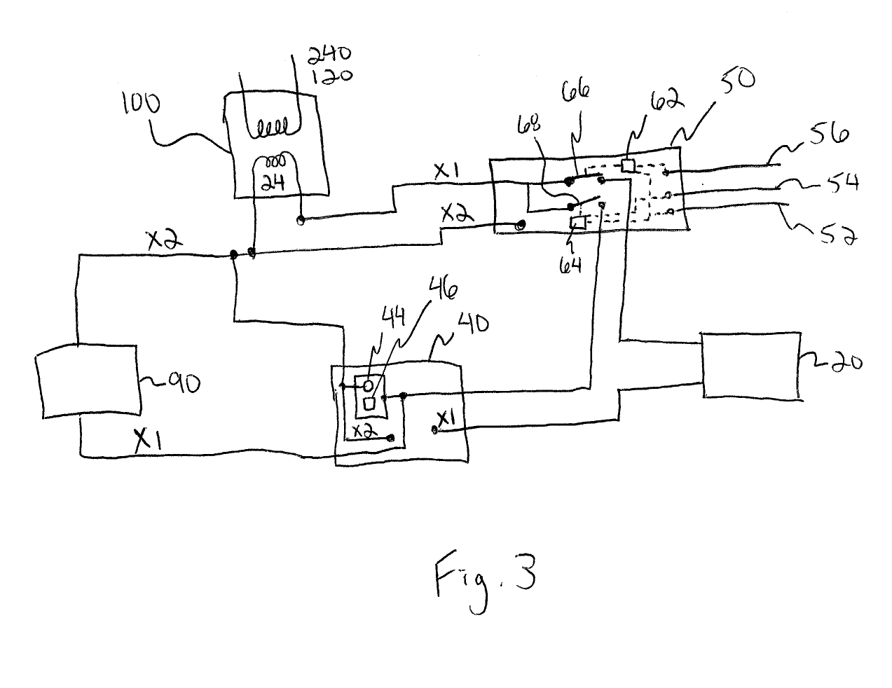

A schematic diagram of the circuitry associated with the blockage detector 50 and the control panel 40, as well as the electrical connection of those elements to the air cooling system 20 is shown in FIG. 3. In FIG. 3, the building includes a transformer 100 that converts a 240 volt or a 120 volt power supply to the common 24 volt power supply. The lines labeled X1 constitute the red (or hot) lines, whereas the lines labeled X2 are neutral lines. The alarm system illustrated in FIG. 3 also is coupled to a dialing unit 90 that will automatically contact a predetermined number, for example, the telephone or pager of an HVAC technician when the alarm condition occurs.

The blockage detector 50 includes a first actuator 62 that is coupled to the common contact 52, the power-supply contact 56 and to an on/off switch 66. A second actuator 64 is coupled to the common contact 52, the alarm contact 54 and to a second on/off switch 68. The actuators 62 and 64 can be solenoids or other actuators, such as electronic switches. When no blockage is present, and liquid does not reach the levels of contacts 54 or 56, the switch 66 is closed, whereas the switch 68 is open. In this state (shown in FIG. 3), power is supplied to the air-cooling system 20 such that it operates as usual.

When a blockage occurs in the drain pipe 70, such that the level of liquid within the drain pan 16 rises to the level of the alarm contact 54, actuator 64 will cause the on/off switch 68 to close. This will supply power to the alarm system within the remote panel 40. Accordingly, the alarm light 44 will be lighted, and an audible alarm, if present, will sound. In addition, the dialing system 90, if provided, will contact the predetermined number so as to request a service call. Switch 66 remains closed such that the air-cooling system 20 will continue to operate as normal. As noted previously, if button 46 is provided, it can be pressed to turn off the audible alarm; however, the visual alarm 44 preferably continues to be lighted.

If the blockage is not eliminated, the liquid will continue to rise within the drain pan 16 until it reaches contact 56. When the liquid reaches contact 56, actuator 62 will cause the on/off switch 66 to open, which will prevent power from being provided to the air-cooling system 20. The alarm system will continue to operate and sound its alarm. Accordingly, no further condensate will collect, which prevents the drain pan 16 from reaching an overflow condition. The air-cooling system 20 will not be able to be turned back on until the blockage is eliminated and the liquid falls below the level of contact 56.

In this way, the technician or homeowner will be provided with an opportunity to eliminate the blockage before the air-cooling system 20 is turned off. If, on the other hand, for some reason the blockage is not eliminated, the air-cooling system 20 will ultimately turn off so that water damage will not occur.

As noted previously, it is desirable to provide indicia 51 on the blockage detector so that it will be attached to the drain pan 16 with a proper orientation. FIG. 4 illustrates one preferred way of achieving this goal. In the FIG. 4 embodiment, the sensor housing 50a has a rectangular (e.g., square) cross-section with the word “TOP” printed as the indicia 51 on one of the four surfaces.

The sensor housing 50b illustrated in FIG. 6 has a circular cross-section with indicia 51 such as the word “TOP” or the words “THIS END UP” provided at the appropriate location thereon.

FIG. 6 also illustrates one preferred construction of the blockage detector. A fitting 53 is provided with a threaded end for attachment to the outlet 15 of the drain pan 16. An O-ring 58 is placed on the end of the fitting 53 opposite from the end containing the threads. The diameter of the O-ring 58 is the same as the diameter of the end of the fitting 53 against which the O-ring 58 is placed. A cap 55 has an internal diameter that slides over the O-ring 58 and the non-threaded end of the fitting 53. Accordingly, the cap 55 is slid over the non-threaded end of the fitting 53 such that the O-ring 58 is held between the end of the fitting 53 and an internal surface of the cap 55 through which a hole 60 is formed. The hole 60 is provided in the cap 55 such that the sensor housing 50b (or 50a of FIG. 4) can slide through the hole 60, and through the O-ring 58 and into the fitting 53. The O-ring 58 seals against the external surface of the sensor housing 50b. Since the fitting 53 is hollow, the contacts of the sensor housing will be exposed to the liquid within the drain pan 16.

The fitting 53 shown in FIG. 6 has external threads, and is for use with a drain pan having an internally threaded (female) drain outlet. Of course, the structure of the fitting will vary depending on the structure of the drain pan outlet. For example, the fitting could be of the female type having internal threads, for engagement with an externally threaded male type drain pan outlet. As another alternative example, the fitting could be a standard coupling with no threads for engagement with a drain pan outlet that does not include threads.

While the present invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

What is claimed is:

1. A blockage detector that is connectable with a condensate drain pan of an air-cooling system, the blockage detector comprising:
a first contact that is coupled to a first circuit that controls an alarm indicating the presence of a blockage in a condensate drain path of the condensate drain pan; and
a second contact that is coupled to a second circuit that controls a supply of power to the air-cooling system, the second contact is not coupled to the first circuit, the first and second contacts are exposed to liquid contained in the condensate drain pan when the blockage detector is connected to the condensate drain pan.

2. The blockage detector of claim 1, further comprising:
a fitting that is attachable to the drain pan of the air-cooling system, wherein the first and second contacts are attached to the fitting.

3. The blockage detector of claim 2, further comprising:
a sensor housing within which the first and second contacts are provided, the sensor housing is removably attached to the fitting.

4. The blockage detector of claim 3, wherein the sensor housing has a rectangular cross-section relative to a longitudinal axis of the sensor housing.

5. The blockage detector of claim 3, wherein the sensor housing has a circular cross-section relative to a longitudinal axis of the sensor housing.

6. The blockage detector of claim 3, wherein the sensor housing has a noncircular cross-section relative to a longitudinal axis of the sensor housing.

7. The blockage detector of claim 3, wherein an external surface of the sensor housing includes indicia that indicates an orientation with which the sensor housing should be attached to the condensate drain pan.

8. The blockage detector of claim 3, wherein the fitting includes a seal on an internal surface of the fitting, the seal engaging and sealing against an external surface of the housing when the housing is inserted into the fitting.

9. The blockage detector of claim 1, further comprising a third contact that is exposed to liquid contained in the condensate drain pan when the blockage detector is connected to the condensate drain pan, the first contact is located between the third contact and the second contact.

10. The blockage detector of claim 1, further comprising a panel that is electrically coupled to at least the first circuit, the panel including an alarm indicator that is electrically coupled to the first circuit.

11. The blockage detector of claim 10, wherein the alarm indicator includes an audible alarm.

12. The blockage detector of claim 10, wherein the alarm indicator includes a visual alarm.

13. The blockage detector of claim 1, further comprising a dialing system coupled to the first circuit, wherein the dialing system automatically contacts a predetermined destination when the presence of the blockage is detected.

14. A blockage detector that is connectable with a condensate drain pan of an air-cooling system, the blockage detector comprising:
a first detector that senses a first level of liquid in the drain pan and that activates an alarm indicating the presence of a blockage in a condensate drain path of the condensate drain pan based upon sensing of the first level of liquid; and
a second detector that senses a second level of liquid in the drain pan and that shuts-off a supply of power to the air-cooling system based upon sensing of the second level of liquid, the second level is greater than the first level.

15. The blockage detector of claim 14, further comprising:
a fitting that is attachable to the drain pan of the air-cooling system, wherein the first and second detectors are attached to the fitting.

16. The blockage detector of claim 15, further comprising:
a sensor housing within which the first and second detectors are provided, the sensor housing is removably attached to the fitting.

17. The blockage detector of claim 16, wherein the sensor housing has a rectangular cross-section relative to a longitudinal axis of the sensor housing.

18. The blockage detector of claim 16, wherein the sensor housing has a circular cross-section relative to a longitudinal axis of the sensor housing.

19. The blockage detector of claim 16, wherein an external surface of the sensor housing includes indicia that indicates an orientation with which the sensor housing should be attached to the condensate drain pan.

20. The blockage detector of claim 16, wherein the fitting includes a seal on an internal surface of the fitting, the seal engaging and sealing against an external surface of the housing when the housing is inserted into the fitting.

21. The blockage detector of claim 14, further comprising a panel that includes the alarm and is electrically coupled to at least the first detector.

22. The blockage detector of claim 21, wherein the alarm includes an audible alarm.

23. The blockage detector of claim 21, wherein the alarm includes a visual alarm.

24. The blockage detector of claim 14, further comprising a dialing system coupled to the first detector, wherein the dialing system automatically contacts a predetermined destination when the presence of the blockage is detected.
